(19) United States
(12) Patent Application Publication
(10) Pub. No.: US 2008/0077613 A1
(43) Pub. Date: Mar. 27, 2008

(54) User Interface Displaying Hierarchical Data on a Contextual Tree Structure

(75) Inventors: John C. Hay, Knoxville, TN (US); James M. Cochran, Knoxville, TN (US); William P. Hughes, Knoxville, TN (US)

Correspondence Address: FISH & RICHARDSON P.C., P.O BOX 1022, Minneapolis, MN, 55440-1022, US

(73) Assignee: FFD, INC., Knoxville, TN (US)

(21) Appl. No.: 11/688,622

(22) Filed: Mar. 20, 2007

Related U.S. Application Data
(60) Provisional application No. 60/827,105, filed on Sep. 27, 2006.

(51) Int. Cl. G06F 17/00

(52) U.S. Cl. 707/103 R

(57) ABSTRACT

A method of creating a document is disclosed. Parent nodes and child nodes associated with the parent nodes are defined in a hierarchical tree. Each parent node contains information associated, with a process. Information in the child nodes are dependent on a position within a hierarchy of the tree and a parent node from which the child node is a descendant Content to be output to the document is determined based on traversing the hierarchical tree, wherein the content depends on the relationships of the child nodes to the parent nodes in the tree.

### CROSS REFERENCE TO RELATED APPLICATION

This application claims priority to Provisional Application No. 60/827,105, filed Sep. 27, 2006, entitled “Integrated Technology for Knowledge Capture Using Digital Images,” which is incorporated herein by reference m its entirety.

### BACKGROUND

Highly-structured documentation continues to grow in popularity for documenting complex themes where information is reused, is hierarchal in nature, and is most-desirably shared electronically. Before the marriage of relational database management systems (RDBMS) and application-specific graphical (or non-graphical) user interface programs, documentation which has some inherent hierarchical structure was largely achieved by applying common text editors, or other desktop applications, to information.

One exemplary application of highly-structured data, is where a writer might document a set of procedures on how to do an ordered set of operations. For instance, consumer products requiring assembly are packaged with an assembly manual containing information pertinent to the final assembly of the product. The information provided might include a hill of materials (BOM), pictures of parts, a list of required tools, and step-by-step instructions with pictures. For decades this ostensibly simple task has been accomplished using text, editors. The same data might be organized using other desktop applications such as spreadsheets programs, or software designed for making slide presentations.

In using such non-database software systems, however, the structure of the data does not allow the software to “know” the meaning of the data. The software has a proprietary structure for storing the data to reproduce the desired formatting and objects, such as tables or text style, but the data is completely arbitrary in how the writer organizes it. More importantly, the text editing software knows how to handle the data inside the text editor, but the text editor does not know the meaning of the data it contains. One true shortcoming of text editors is that the structure of the data is a barrier to readily sharing data with other software systems that use some or all of the same data. This situation leads to the extremely undesirable situation of dual entry in two disconnected systems, risking data integrity. For example, it is common in consumer products to encounter situations where the parts in the parts kit do not match those listed in the parts list of the assembly manual.

Relational database management systems, on the other hand, are highly structured. In particular, the tabular structure of data in databases allows for extremely efficient storage, management, and retrieval of data. The advantage the database for storing information is that keys can be used to relate data in one table with data in another table achieving an effective means for filtering and reporting information.

In another area of software development, development tools have evolved to include objects, permitting designers to model physical, data, in a variety of ways. A tree object can convey parent-child relationships between data. For instance, an organizational chart is easily represented in a tree and is very conveniently stored in a database since the tree is simply a series of parent-child relationships.

However, there are at least two distinct disadvantages to the conventional methods of using data on a tree structure. First, there are many situations where it is desirable for attributes of a common child object to be identical, except for some small detail. For example, an instruction for setting the temperature on a furnace may be written as a global instruction that is in turn used as a child of multiple parent objects on the tree. However, the set point, or target temperature, of the furnace might vary from process to process. Conventional use of the tree class of objects does not allow child object properties to change based upon parent nodal properties.

Second, when hierarchical data is outputted to a document or to an electronic system, there are benefits in using context to determine what information is presented and how it is presented, in this paradigm context means the properties of the parent and grandparent objects (or a user attribute, perhaps) and location of the node relative to its parent and siblings to tell the output system how to present the data.

### SUMMARY

Disclosed herein are systems and methods of creating a document, in one implementation, parent nodes in a hierarchical tree are defined, wherein each parent node contains information associated with a process. Child nodes associated with parent nodes in the tree are also defined, wherein information, in the child nodes are dependent on a position within a hierarchy of the tree and the a parent node from which the child node is a descendent. Content to be output to the document is determined based on traversing the hierarchical tree, wherein the content depends on the relationships of the child nodes to the parent nodes in the tree.

In another implementation, a parent node is defined in a hierarchical structure. One or more child nodes are also defined from the parent node, wherein data in each child node depends on a position within the hierarchical structure and the parent node from which the child node is a descendent. The data from the parent node and each child node is organized into one or more documents based on traversing the hierarchical structure.

In another implementation, a parent node is displayed on a tree structure on a portion of the user interface. One or more child nodes are also displayed on the tree structure on the portion of the user interface, wherein each child node is associated with one or more parent nodes. Data from the parent node and one or more child nodes is extracted based on the arrangement of the parent node and one or more child nodes on the tree structure, wherein the data in the one or more child nodes depends on a position of each child node on the tree structure. The extracted data is displayed on a different portion of the user interface.

### DESCRIPTION OF DRAWINGS

FIG. 1 is a block diagram of an example system environment 100.

FIG. 2 is another block diagram of the system environment of FIG. 1.

FIG. 3 is an example of a client-server application interface.

FIG. 4 is an example of a text editor interface 832.

FIG. 5 is an example of a picture editor interface.

FIG. 6 is an example of a spreadsheet document editor interface.

FIG. 7 is an example of a read-only deployment interface.

FIG. 8 is an illustration of a representative hierarchical structure in the system database 400.

FIG. 9 is an example of a text tag that has been include in a text step.

FIG. 10 is an example of a subassembly that, has been selected on a process tree.

FIGS. 11a and 11b are examples of sample PDF output.

FIG. 12 is an example of output presented in a web-based module.

FIG. 13 is an example of a process tree.

FIG. 14 is another example of a process tree.

FIG. 15 illustrates a flow chart of an exemplary process for organizing data.

FIG. 16 Is an exemplary user interlace.

FIG. 17 is a flow chart of exemplary processes performed to import pictures and associate the pictures with objects in a database.

FIG. 18 is the exemplary user interface of FIG. 15 illustrating an imported picture.

### DETAILED DESCRIPTION

A system and user interface is presented in which the properties and context of nodes in a hierarchical tree define how information is related and presented in an output. For example, a method of using context as a means for affecting the properties of an object that may have multiple parents on a tree structure is illustrated. The context can affect content of the common object and how code may use context in determining how to output the data. Several exemplary implementations are presented in which context is used in an application for the manufacturing sector. It is noted that the implementations are not limited to the manufacturing sector, as this is provided for exemplary purposes.

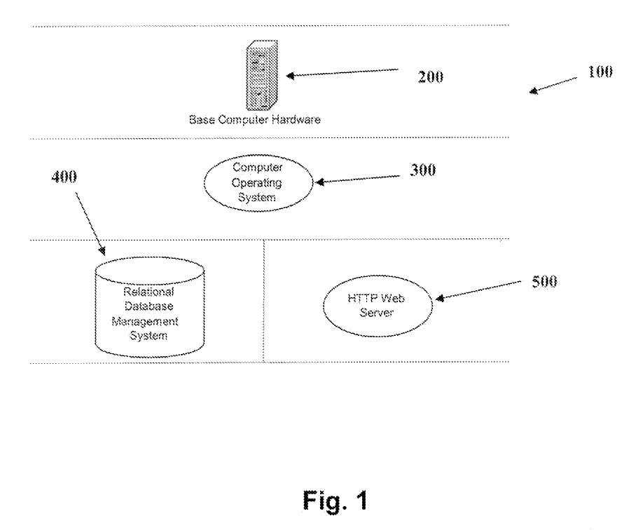

FIG. 1 is a block diagram of an example system environment 100. One implementation can comprise software modules that capture information from persons and redisplay that information in a variety of outputs suitable to the environment. The system 100 can include a stack of subsystems built upon an industry-standard model of base computer hardware 200, computer operating system 300, relational database management system 400, and a web server 500 (depending on configuration). In one implementation, the stack of dependencies can be based upon a platform, e.g., a Microsoft platform. Alternatively, the stack can operate on other platforms, such as Linux. Because the system 100 is modeled as a logical system, it can be ported, to alternative platforms to meet design requirements.

The base hardware 200 to operate these subsystems is typically an Intel compatible computer running the Microsoft Windows operating system (operating system 300). Any operating system 300 will be sufficient for the system 100. The operating system 300 which controls logical access to hardware resources runs the next layer of the stack, the Relational Database Management System (RDBMS) 400 and the HTTP or Web Server 500. In one implementation, the system utilizes Microsoft SQL-Server 2000 or later as the RDBMS 400, and Microsoft internet information Server 4.0 or later as the Web Server 500.

In one implementation, logical data generated in the system 100 are stored in the RDBMS 400, as the system 100 does not physically store that data on media. The RDBMS 400 is also responsible for enforcing data integrity rules as well as some low-level communications between the database and system components.

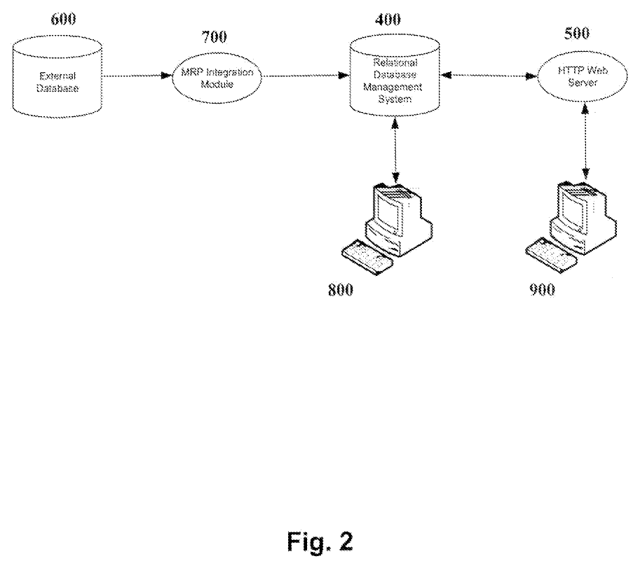

FIG. 2 is another block diagram of the system environment of FIG. 1. Referring to FIG. 2. system 100 can comprise a module 700 which synchronizes shared data with external database systems 600 having their own relational database management systems. In one implementation the external database system 600 can be a single data source, such as a manufacturing resource planning (MRP) system. However, data may be shared with additional relational database management systems.

The data synchronization is performed to eliminate dual entry of common data desired in different business applications. The concept is to import data maintained in other systems on a customer-defined schedule so that the information is identical in both databases 600 and 400.

In one implementation, the data synchronization process implemented by the Integration module 700 follows configurable rules that can be modified to accommodate a variety of applications:

1) Information imported from the external database 600 cannot be modified in the RDBMS 400 so that data discrepancies are kept to a minimum and errors from dual entry of data are eliminated.

2) Information imported from the external database 600 can be refreshed in the system RDBMS 400 on a defined cycle, so that data discrepancies can be periodically resolved.

3) Information imported from the external database 600 is presented in a defined format, so that different external databases 600 can be accommodated.

4) Information presented includes data for external references. Therefore, if an object in the hierarchical data structure of the external system 600 refers to a child object, the child information is available for synchronization.

5) Information imported from the external database 600 is complete and representative of entire logical structures. For example, no directives such as “add record x” or “alter record y” are accommodated. If the child list for a given parent is provided to the integration process, on the next cycle the entire child list for that parent must be complete or items will be removed in the system RDBMS 400.

External data from the external database 600 integrated to the system database 400 is typically represented as discrete objects in a few different categories. For example, in the manufacturing sector example, parts and subassembly records are imported as global references, so that wherever a part is used in multiple subassemblies, the part is the same record in the system database 400 and the same object on the tree. Likewise, if an MRP procedure or Routing is imported, that routing is a global reference wherever it is used on the tree. MRP, subassemblies, routing, routing operations, and work orders are commonly used terms and are familiar to anyone experienced in the art of manufacturing.

In the manufacturing sector example, the MRP integration module 700 can import the following discrete data objects, and listed beneath them are representative attributes of those objects. This list of objects is certainly not exhaustive and naturally depends on the particular business model.

1) Paris
a. Part Number
b. Revision
c. Name
d. Type of Part
e. Cost

2) Subassemblies
a. Part Number
b. Revision
c. Name
d. Type of Part
e. Cost
f. List of component parts

3) Routing
a. Identifier of Routing
b. Name of Routing
c. List of steps in the routing, in order

4) Work Order
a. Part number being ordered
b. Quantity on order
c. List of parts being delivered to manufacturing

When an integration process begins in the MRP integration Module 700, the system 100 follows a general series of steps for objects to be synchronized, as noted above. If the object exists in the system database 400, then it updates attributes of that object according to the data from the external database 600. If the object, does not exist in the system database 400, then it creates the object in the system database 400. For objects that are parents of other objects, such as a subassembly, work order, or routing, the Integration Module 700 will next verify that the children of those objects are linked to the correct parents, in the correct order.

Additionally, for work orders, a set of text tag objects (described below) can be imported so that these values will override any values set for the subassembly the work order refers to.

With reference to FIG. 2, in one implementation, a client computer 800 running a system application 810 interfaces to the RDBMS 400. Multiple users can interact with the same data where additional clients (e.g., client 900) are implemented. Although the system described is implemented as a client-server application, the same concept of editing data in a database can be achieved in a web-based interface. In a multi-user and web deployment configurations, the system can use the web server 500 as an interface to the data, or alternatively, a client-server application interface.

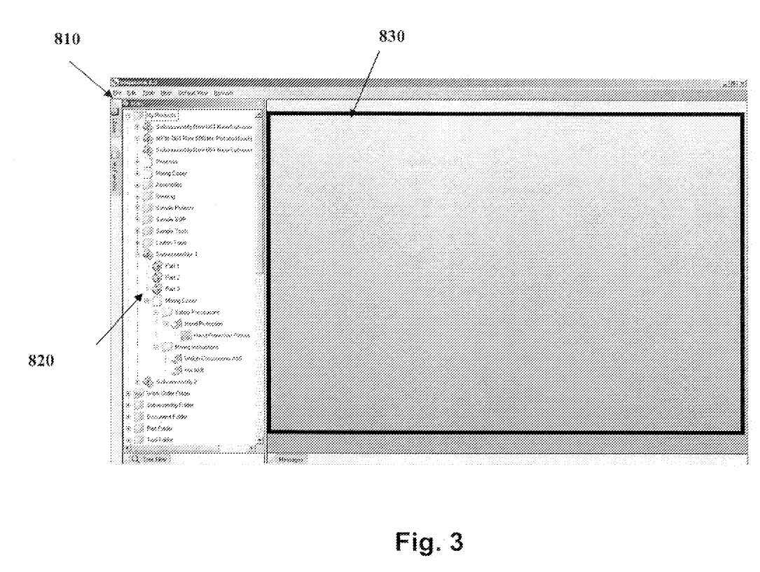

FIG. 3 is an example of the client-server application interface 810. The client-server application 830 running on a computer 800 is used for inputting or changing data in the database 400 and has two visual features: a documentation tree 820 and a set of editors in an area 830 for editing the contents of different types of objects. The tree 820 is constructed based on hierarchical relationships stored in the database.

The documentation tree 820 can be used for organizing the order in which information is to be presented to end users in production. Functions associated with particular classes of objects, including tree objects, allow users in the editing interface 810 to drag and drop objects on the tree, in one implementation, objects can be reordered on fee tree by drag and drop. The order on the tree specifies the order in which information is presented to the end user. In another implementation, the interlace allows the user to create new instances of global objects, or to create copies of non-global objects by dragging and dropping objects to other nodes on the tree.

The software interface 810 has an area 830 reserved for editing each object type allowable on the documentation tree 820. In some implementations the editor operates as a standard form, containing text fields that can be modified for the object. In other implementations, more elaborate editors are available.

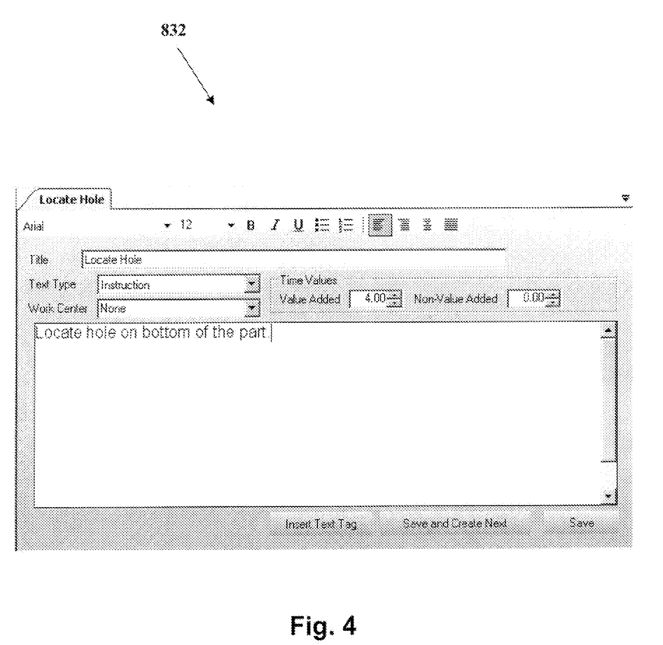

FIG. 4 is an example of a text editor interface 832. The text editor interface 832 allows the user to create prose of arbitrary length. The text editor can include the basic functionality allowing users to change font, style (hold, italics, underline), justification, and bulleting. The exact functions of the text editor can be modified from those specified without changing the scope of the claims herein.

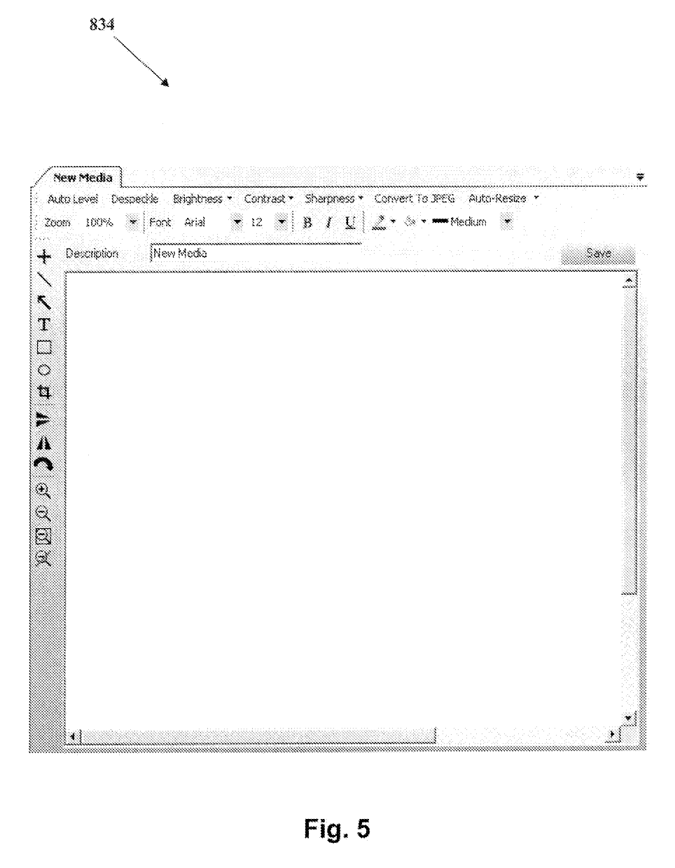

FIG. 5 is an example of a picture editor interface 834. The editing interface 834 allows users to edit raster images without the need for third party picture editors. The benefit is that the system can track all changes for revision history. The picture editor has the basic functionality used in documenting manufacturing processes including lines, arrows, text annotations, circles, rectangles. The user may crop, flip, and rotate images as well as apply basic filters to the image including brightness and contrast. The specific functions included in the picture editor do not affect the overall effectiveness of the implementations herein and therefore may be changed from those specified.

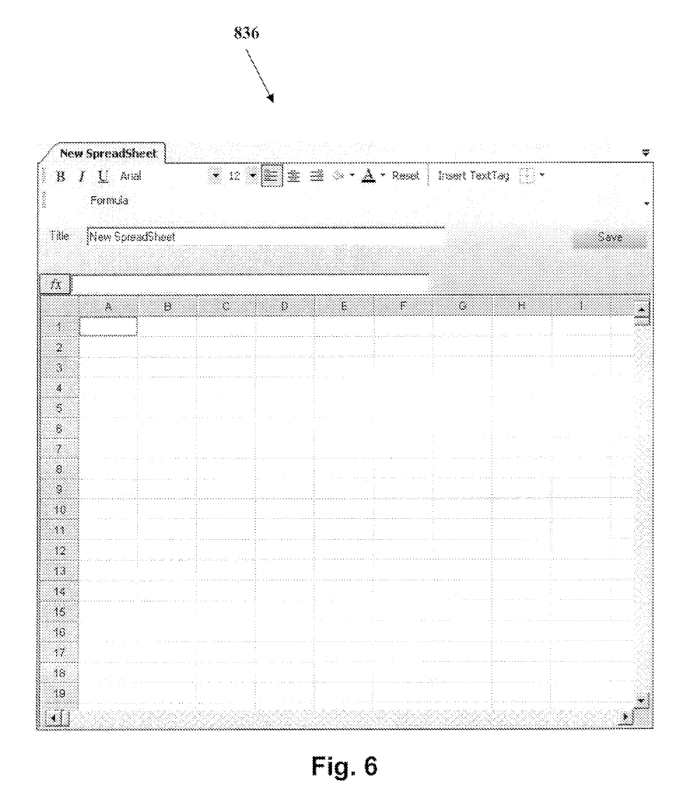

FIG. 6 is an example of a spreadsheet document editor interface 836. The spreadsheet document editor allows users to attach spread sheets as child objects to various types of parent objects on the documentation tree 820. Changes to a spreadsheet made using the internal spreadsheet editor 860 are contained within the database system 400 making previous versions of the table available for retrieval.

In other implementations, editors for other types of data can be included in a system such as that specified here without changing the effectiveness or scope of the implementations herein. Some additional useful editors might include audio, video, or vector document editors.

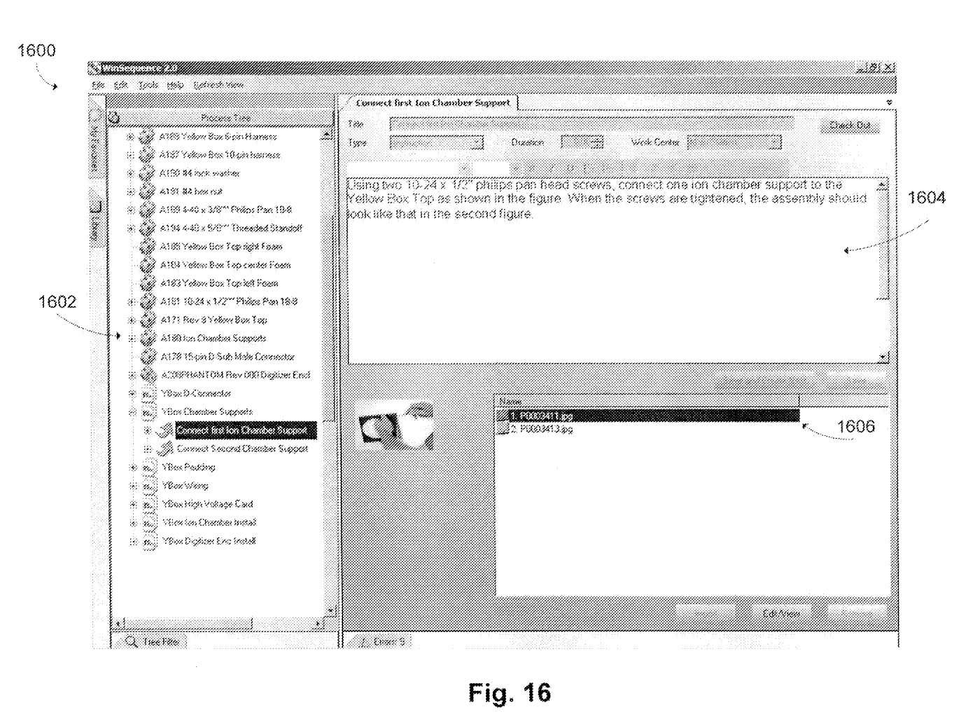

In one implementation, other technologies such as digital cameras can be integrated with the documentation. In an implementation, the user can attach a camera to the computer 800 via the USB port. When the user depresses the shutter release on the allowable cameras, the system detects the shutter release and automatically imports the picture into the system database 400 and attaches the image to the selected object on the tree, if the object selected on the tree does not allow for attached raster media, the picture is not copied to the system database 400. Wireless connections can be used between the camera and PC. Other types of digital imaging equipment, such as scanners or video recorders, can also be used in the system. The process of detecting and importing a picture is more fully described below with reference to FIGS. 16-19.

The editing interface 810 allows for drag and drop of some types of media from the operating system environment. The media types can be, for example, JPEG, PDF, AutoCAD, .doc, MPEG, AVI, MP3, and WAV. JPEG type raster images and the DXF and DWG type vector objects can be dragged directly from a file folder and onto the documentation tree 820. If the drag-to-object on the tree permits a child media type object, the document is copied from the original file location to the system database 400.

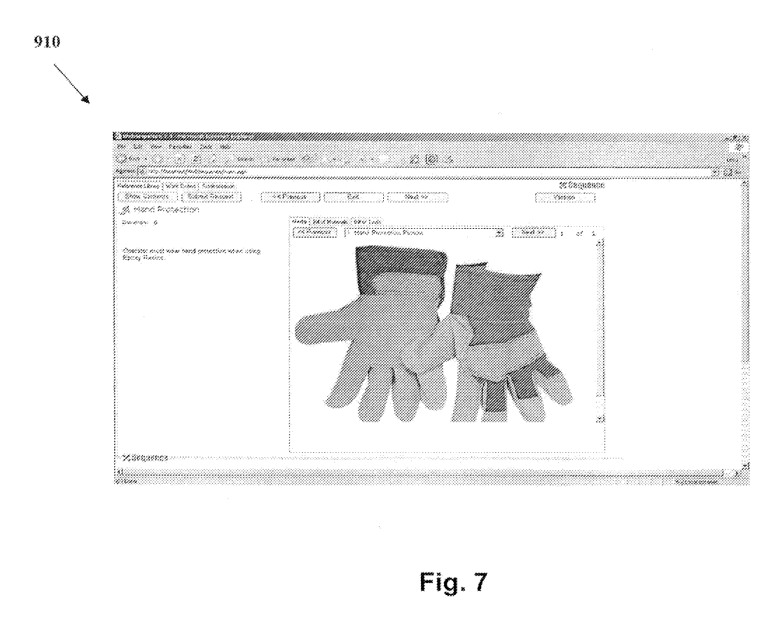

As shown in FIG. 7, the system 100 implements an interface for retrieving information for read-only access. In a first implementation, access is provided in an electronic format utilizing web browsers, such as Microsoft Internet Explorer, Mozilla Firefox, or Apple Safari.

In the system 100, the computer 800 running the web browser accesses the data in the database 400 through the web server 500 and a user interface 910. The user interface 910 filters and presents data in an appropriate manner. In another implementation, the output method could also be of a different type, such as the client-server application described above.

The user can employ a variety of integrated technologies to retrieve information from the system database 400. Barcode scanners, for instance provide rapid access to desired work order or part information. Users can also use the conventional mouse and keyboard interfaces to retrieve the same data from the system database 400.

It is also possible to track information solicited from end users on this interface using the described system. Typical information allowed includes electronic signatures and process data, as well as requests for changes to the data. Process data are generic in nature but might be used for capturing lot information of materials used in production, for instance, or recording serial numbers of parts used in assembly.

Alternatively, the user may use style sheets to transform XML formatted data to a portable document format (PDF). In this configuration, the system has at least one computer 800 with an editing interface. That interface has an option to convert data in the database into a portable document format (PDF) that has a predetermined style controlled by a series of style sheets. Users can achieve the same PDF from the output interface in FIG. 5. Output and other methods of transformation can be employed to take data from the system database 400 and put that data into a document format other than PDF.

A tree can contain objects having different properties. Data integrated into the system database 400 can be represented as discrete objects in a few different categories. The system can document assembly processes in manufacturing and has logical object types for that business application.

Table 1 illustrates the different objects that can be used inside the present manufacturing application. The specification of objects is only intended to illustrate one possible set of objects that might be used in the contextual representation of hierarchical data and is not limiting. Table 1 also illustrates for any parent object the allowable child objects.

TABLE 1

| | | Child Objects | | | | | | | | |
|---|---|---|---|---|---|---|---|---|---|---|
| | | [symbol] | | | | | | | | |
| | | Work | [symbol] | [symbol] | [symbol] | [symbol] | [symbol] | [symbol] | [symbol] | [symbol] |
| Parent Objects | | Order | Subassembly | Part | Folder | Section | Document | Text | Tool | Media |
| [symbol] | Work Order | | [symbol] | [symbol] | | [symbol] | [symbol] | | [symbol] | [symbol] |
| [symbol] | Subassembly | | [symbol] | [symbol] | | [symbol] | [symbol] | | | [symbol] |
| [symbol] | Part | | | | | | | | | [symbol] |
| [symbol] | Folder | | [symbol] | [symbol] | [symbol] | [symbol] | [symbol] | [symbol] | [symbol] | [symbol] |
| [symbol] | Section | | | | | | [symbol] | [symbol] | [symbol] | |
| [symbol] | Document | | | | | [symbol] | [symbol] | | [symbol] | [symbol] |
| [symbol] | Text | | | | | | [symbol] | | [symbol] | [symbol] |
| [symbol] | Tool | | | | | [symbol] | [symbol] | | | [symbol] |
| [symbol] | Media | | | | | | | | | |

The rules which govern allowable relationships are attributes of the objects themselves. For instance, a “media” type object is the only allowable child object for a “part” type parent.

Objects on the documentation tree 820 are either global or non-global The term “global” as used herein means that the same object can be attached as a child of several different parent objects in the documentation tree 820. When attributes of the global object are changed by the user the updated material will he presented for all parent objects that have the global object as a child. The practice of using global instructions is familiar to those in the art of documenting various types of processes, in particular manufacturing processes.

In Table 1, four of the objects are treated as global objects: subassemblies, parts, tools, and documents. In a manufacturing environment and Table 1, global objects may have other global objects as children. Thus, an assembly procedure may involve one or more subassemblies which in turn have their own assembly procedures. Extending this process makes a tree structure apparent.

Each global reference may have a one or more states in the database system 400 at any given time. The data for state are kept distinct in the system database 400 so that changes to state will not affect the others. For example, a global reference can be in an ‘edit’ status, which means that it can be modified by an authorized user. At the same time, a ‘published’ version of that global reference can exist, which would be the version of documentation that has been approved for general use and can no longer be modified. Another status is ‘retired,’ where a global reference can have multiple versions in this status, which are archived for historical purposes. When an item in edit status is approved for public use, the published version of that item and its non-global children are moved to retired status, the edit status items are changed to published, and then copied to an edit status so that the process can be started again. The exact number of states and the rules governing the states of the global references can change without affecting the scope of the claims herein.

The system uses context to affect formatting in the output in at least two ways: (1) allowing attributes of the object to inherit properties from the parent or higher object, and (2) presenting data to the user in formats based on the position of the node relative to the tree and the ultimate parent node,

### Text Tags

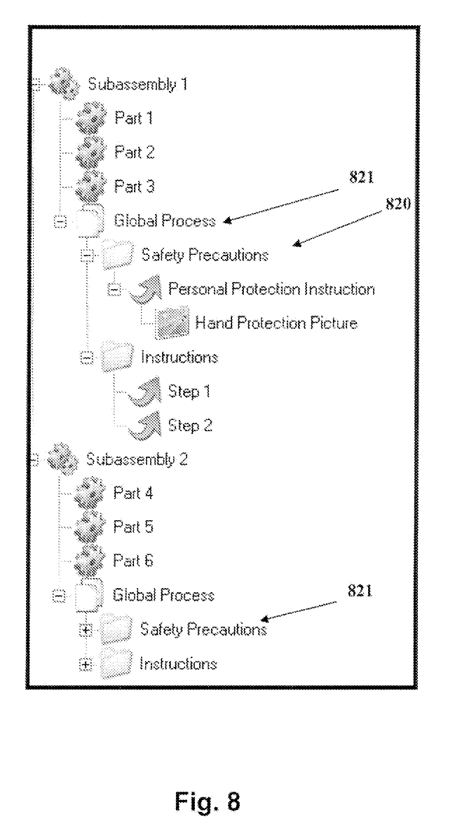

FIG. 8 is an illustration of a representative hierarchical structure in the system database 400. The same global child object (i.e., record) can attached to two different parent objects at the same time, but characteristics of the global child are inherited from the parent. The sample data in FIG. 8 relate to two different subassembly objects that have the same global process as children. However, there are instances where a descendent detail in the global process may differ depending on the parent to which the child process is attached.

One example of how this concept is employed is through a feature called a “text tag,” which is a variable that can be included on a descendent node of the global child, object. The text tag name is included in a lower descendent object of the global child and the value for the variable can be set at a higher parent node on the process tree 820.

As an illustrative example, the process tree 820 in FIG. 8 references two different subassemblies that use the same global process 821 as a child, in this example, a text tag 833 has been included in a text step using the text editor 832.

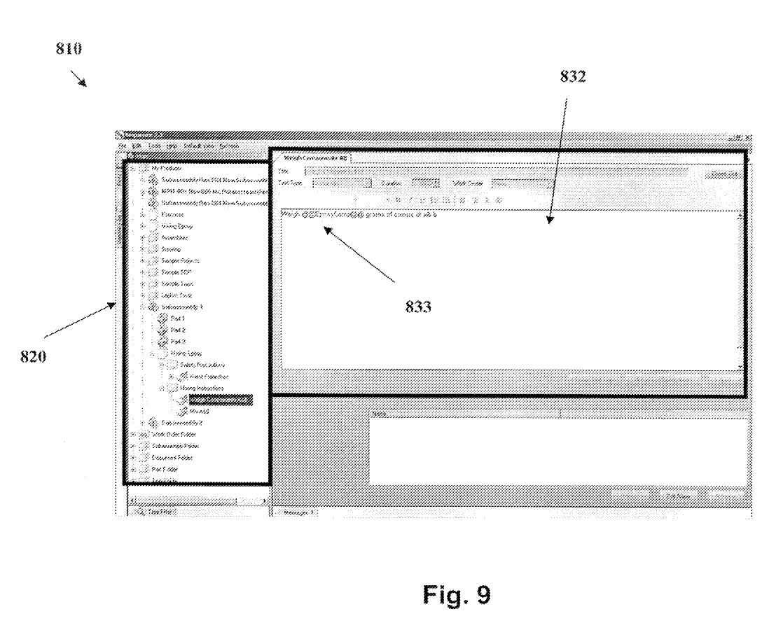

FIG. 9 is an example of a text tag that has been include in a text step. In the present application the text tag name starts and ends with the “@@” character string. The use of this literal string is not inherent to the implementations and can be changed without changing the scope of the claims herein. Likewise, methods other than character strings can be used to identify text tags in the object data.

The value the text tag is to assume is determined by a higher parent on the tree (in this example Subassembly 1 or Subassembly 2 in FIG. 8). In one application, the user selects the parent node on the process tree 820 where the text tag value is to he set by left-clicking the object on the tree.

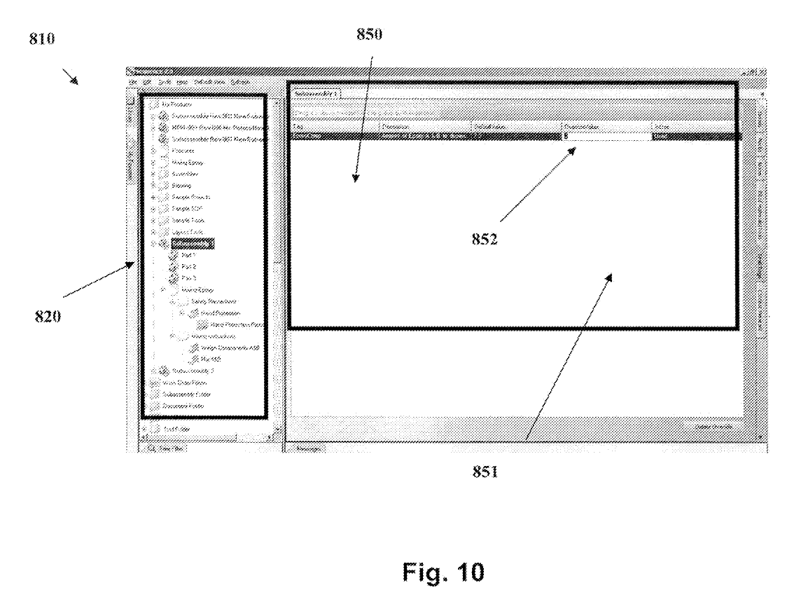

FIG. 10 is an example of a subassembly that has been selected on a process tree. In the illustrative example, Subassembly 1 has been selected on the process tree 820 and the “Text Tag” tab 851 has been selected by a left-click. The selection opens the Text Tag editor 850 within the editing area 830. The desired value for the text tag on the parent node (Subassembly 1 in this illustrative example) is set 852.

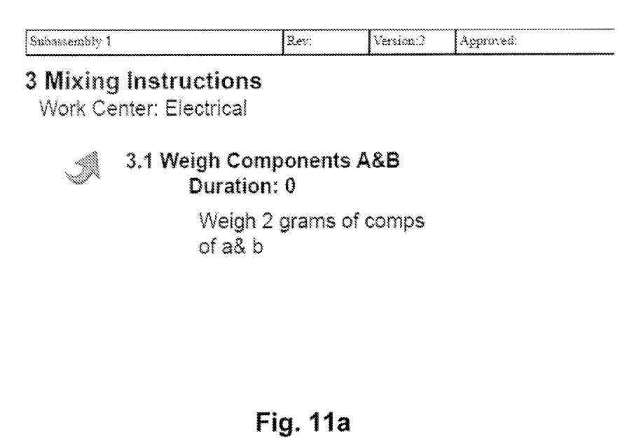

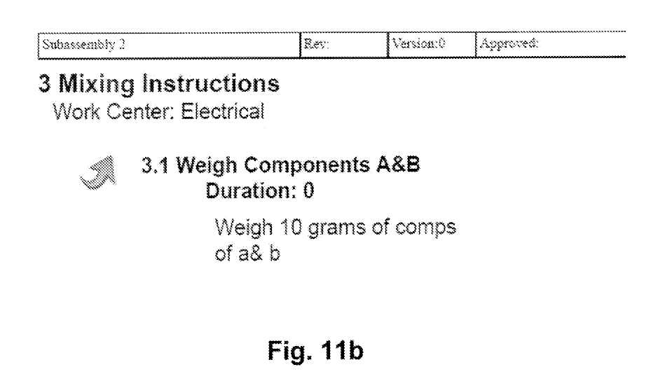

FIGS. 11a and 11b are examples of sample PDF output. FIGS. 11a and 11b contain sample PDF outputs where Subassembly 1 and Subassembly 2 have assumed two different values 852 for the text tag 833 entered in the text editor 832. Other document output formats can he support, such as XML, Microsoft Word, ASCII text, etc.

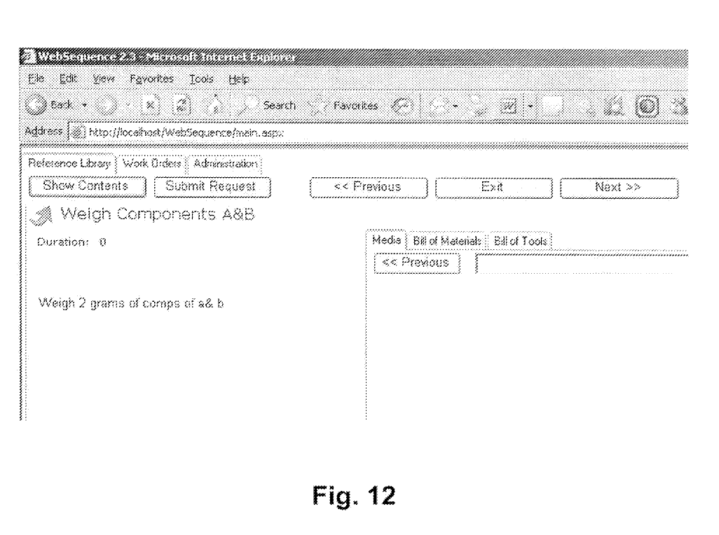

FIG. 12 is an example of output presented in a web-based module. The output is presented in the web-based module of the present system for deploying information electronically.

Thus, in accordance with the above implementation, a generic process can he written once and the parameters (e.g., text tag values) for the generic process are easily controlled in a single grid on the object using the generic instructions. There is no limitation on the number of text tags that may be included below a parent object.

### Context Materials

In another implementation, the system can be used to manage global information in the context of parental information is the division of parts on a summary BOM by routing operation. While the concept will be familiar to those experienced in the art of manufacturing, a routing is one typo of global child for a parent assembly or process. In this example of contextual use of global references, if is desirable to ascribe parts from the summary BOM to operations on a routing.

If operations are assigned to different work stations in the manufacturing environment, the operator at any one station only needs to see the parts associated with his/her operation on the global routing. Because the routing can be used on different products the operation will be globally the same, but the parts used in the process may be different. This is very common In manufacturing styles that have families of products where assembly is performed the same way, but the actual parts are different for different models.

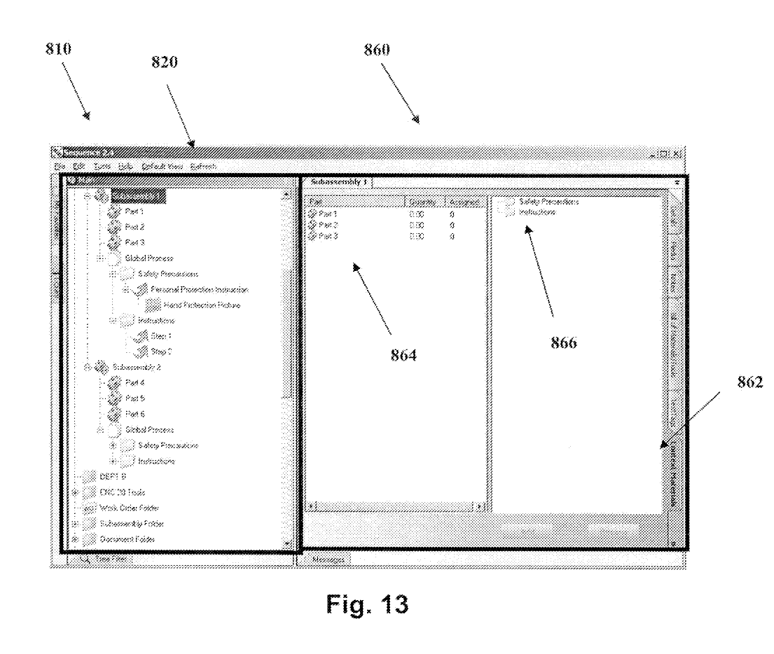

FIG. 13 is another example of a process tree 820. In the system described here the user can uses the editing interface 810 and identifies a specific subassembly on the process tree 820 by left-clicking the object. A Context Materials interface 860 is activated by selecting the tab 862. To assign parts from the global parent assembly to operations on the global routing child the user drags parts from the summary BOM 864 to the operation list 866. The system then queries the user as to how many of the unassigned parts should be assigned to the operation. Thus, the parent object using the global child object determines the parts, in this ease, that show up when the global child object is used. The drag and drop event for assigning parts to operations is not exclusive of other methods for assignment and does not limit the scope of the claims herein.

### Context for Output

The manner of handling the contents of a global child object can depend on the characteristics of the parent to which it is attached. Three exemplary cases can be considered with respect to handling global references when they are attached to various objects on the tree:
1) Attaching a global document to a global object
2) Attaching a global document to a section
3) Attaching a global document to an instruction

### That is, the contextual use of the global document determines how it is displayed in the output.

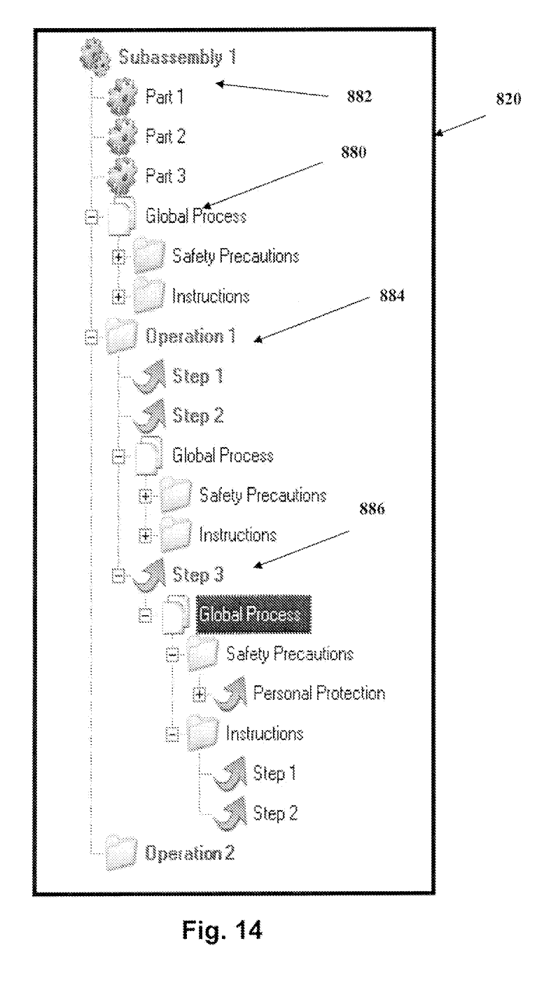

FIG. 14 is another example of a process tree. A global object can he a child node of different types of parent nodes on the process tree 820. In FIG. 14 a global object 880 is attached to another global object 882, a section 884, and an instruction 886. When a global object 880 is attached to a second global object the system treats the contents of the global object 880 like sections 884. The net effect is the user can create global sections that are used on different processes.

When a global object 880 is attached to a section 884 the system treats the contents of the global object 880 like instructions. That is, the system will extract just the instructions from the global reference 880 and print them in line in the output interface 910 or the PDF output with the instructions above and below the global object 880. The net effect is that the user can create a wrapper around specific instructions that are repeated on different sections, where not all instructions in the section are global.

In writing documentation of any type writers speak of the “writers' triangle”, which concisely means one must consider the subject, purpose, and audience when writing. In manufacturing there exist multiple purposes and audiences for whom the documentation may be intended. Thus, the contents of the output arc ideally dynamic to conform to different audiences that have different purposes for the documentation. In the present application the system has been designed to alter the output to include more or less detail depending on the characteristics of the audience to receive the output. The easiest delineation is between “expert” and “novice” operators in manufacturing, which concisely differentiates between those who know the process and those who may have never performed the process.

When a global object 880 is attached as a child to an instruction 886, the contents of the global reference 880 are excluded or included in the output based upon whether the instructions are outputted for an “expert” or a “novice”. The system Interprets the contents of a global object 880 to be sub-steps of the instruction 886 to which it is attached. Whether the sub-steps are displayed in the output depends on whether the user is an “expert” or a “novice”. The benefit to the user is that, all of the documentation on the process tree 820 does not need to be changed to accommodate different levels of information in the output.

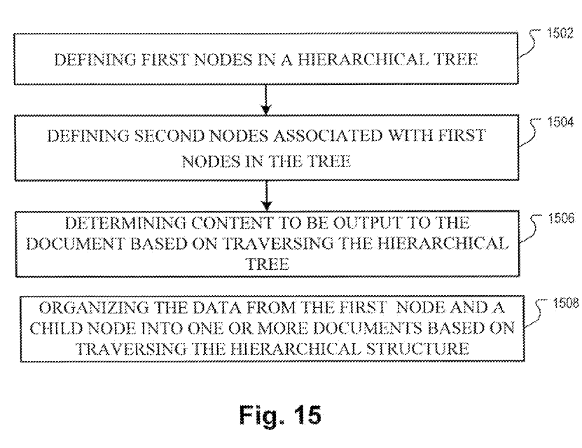

FIG. 15 illustrates a How chart of an exemplary process 1500 for organizing data. Step 1502 defines first (e.g., parent) nodes in a hierarchical tree. For example, RDMS 400 can define first nodes in a hierarchical tree through relationships defined between record entries in the database. Step 1504 defines second (e.g., descendant, child) nodes associated with first nodes in the tree. For example, RDMS 400 defines second nodes associated with first nodes in the tree. Step 1506 determines content to be output to the document based on traversing the hierarchical tree. For example, RDMS 400 determines content to be output to the document based on traversing the hierarchical tree. In one implementation, determining content to be output to the document based on traversing the hierarchical tree comprises extracting information associated with each second (child) node based on its relationship to the first node, extracting information from each first node, and compiling the information into the document. Step 1508 organizes the data into one or more documents based on traversing the hierarchical structure. For example, RDMS 400 organizes the data from the first and second nodes into one or more documents based on traversing the hierarchical structure. Steps 1506 and 1508 can be performed independently of steps 1502 and 1504.

As noted above, in some implementations, a picture can be associated with an object. Using a USB port or the like, a user can connect a digital camera to a computer that is running the interface. The user can import a picture or image into a selected object in the object tree upon a shutter release. For digital cameras, such as those listed in Table 2, the system 100 can detect a shutter release.

TABLE 2

| Manufacturer | Model |
|---|---|
| Nikon | D50 |
| Nikon | D70 |
| Nikon | D70s |
| Nikon | D90 |

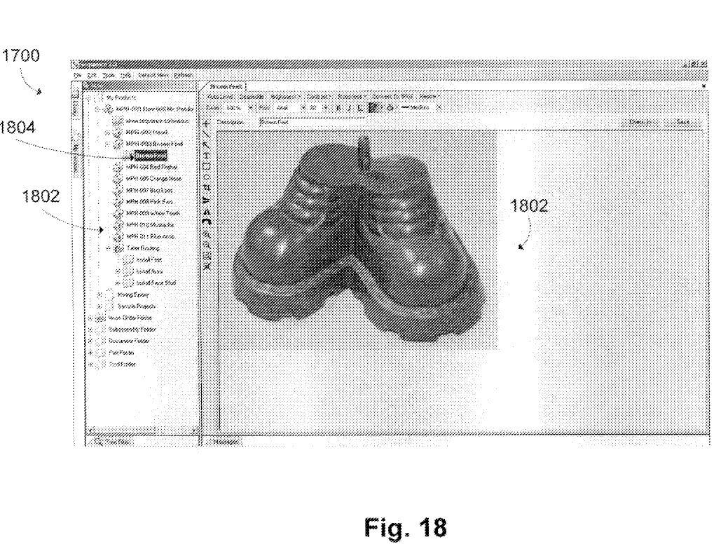

FIG. 16 illustrates an exemplary user interface 160 to the system to capture, manage, and disseminate the knowledge to build, e.g., a manufacturer's products. The user interface enables a user to interact with objects 1602 stored in a database that are associated with the captured knowledge. The user can create text steps that describe processes using a text editor 1604 provided within the interface. The user can also edit pictures associated the steps using a picture editor (See, reference numeral 1802 in FIG. 18). in some implementations, the user can create the instructions in the interface and export the data to a preformatted Portable Document Format (PDF) using supplied style sheets, to the web using a module that creates dynamic HTML, or other tagged file formats.

In some implementations, data within the database can be shared with other systems. Bills of Materials (BOMs), routings, and work orders from the Materials Requirements Planning (MRP) or Enterprise Resource Planning (ERP) system can be imported into the system. In the manufacturing sector, the BOMs and Routings form a skeleton around which the step-by-step instructions with pictures can be created by the system.

In some implementations, the system can utilize a database that contains both the structure of documentation as wed as the content. The objects 1702 in the system are synonymous with discrete database rows in a table, and can be of several types. When the interface 1700 displays the data stored in the database, it assembles objects 1702 based upon these discrete rows and links them into parent-child relationships based on the contents of a relational table. When new objects are created, a row is created in the database and the new item is linked to a parent object. Additionally, when objects 1702 are manipulated in the user interface 1700, this parent-child relationship can change, and the change will be stored In the database.

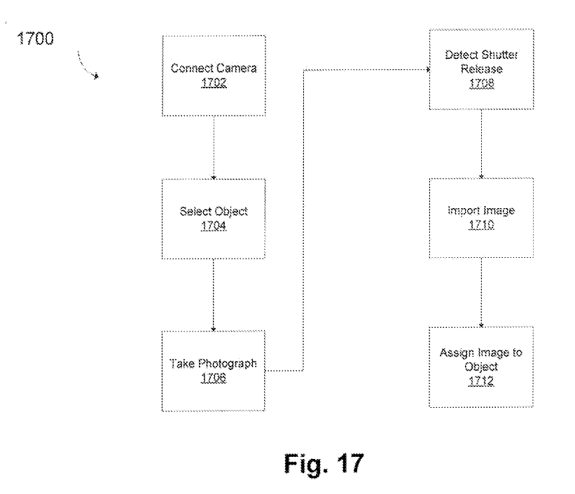

FIG. 17 illustrates a flow chart of exemplary processes 1700 to import a picture into the system. Using the menu provided in the camera, the user changes the value of a USB parameter from Mass Storage to Picture Transfer Protocol (FTP, ISO 15740). The camera is then connected to the computer using a USB port in the computer (step 1702). When the computer operating system program-selection box shown in FIG. 17 appears, the user clicks the Cancel button. Next, an object in the interface object tree that can accept a Media object is selected (step 1704). The process tree in the interface is rides-based, meaning that the nodes accept certain types of children based on properties of the parent and child. The user then takes a picture with the camera (step 1706). When the operating system and/or application detects the shutter release of the camera (step 1708), the raw image (e.g., in JPEG format) is imported into the selected object in the object tree using the FTP protocol (step 1710). A progress bar can be shown during the import. The image is then associated with the selected object (step 1712). The default name of the new Media object will be the name assigned by the camera. The resolution of the image in the Media object is determined by the resolution setting on the camera.

As shown in FIG. 18, the user can edit an imported picture 1802 associated with an object 1804 from within the interface 1700.

The apparatus, methods, flow diagrams, and structure block diagrams described in this patent, document may be implemented in computer processing systems including program code comprising program Instructions that are executable by the computer processing system. Other implementations may also be used. Additionally, the flow diagrams and structure block diagrams described in this patent document, which describe particular methods and/or corresponding acts in support of steps and corresponding functions in support of disclosed structural means, may also be utilized to implement corresponding software structures and algorithms, and equivalents thereof.

This written description sets forth the best mode and provides examples to describe implementations and to enable a person of ordinary skill in the art. Tins written description does not limit the implementations to the precise terms set forth. Thus, while implementations have been described in detail with reference to the examples set forth above, those of ordinary skill in the art may effect alterations, modifications and variations to the examples without departing from the scope of the claims that follow.

What is claimed is:

1. A method of creating a document, comprising:
defining a first node in a hierarchical tree that contains information associated with a process:
defining a second node associated with the first node, wherein information represented by the second node is dependent on a position within a hierarchy of the tree and the first node from which the second node is a descendent; and
determining content to be output to the document based on traversing the hierarchical tree, wherein the content depends on the relationships of the second node to the first node in the tree.

2. The method of claim 1, wherein determining content to be output to the document based on traversing the hierarchical tree comprises:
extracting information of the second node; and
extracting information of the first node.

3. The method of claim 2, further comprising:
compiling the information into the document.

4. The method of claim 1, wherein determining content to be output to the document comprises:
determining an audience to receive the document.

5. The method of claim 4, further comprising:
creating the document based on the audience.

6. The method of claim 1, wherein the document is in one of a PDF format or a tagged file format

7. The method of claim 1, wherein the first node and the second node are each associated with an object.

8. The method of claim 7, wherein each object has one or more states that define a status of each object.

9. A method of organizing data, comprising:
defining a first node having first data in a hierarchical structure;
defining a second node, wherein second data associated with the second node depends on a position within the hierarchical structure and the first node from which the second node is a descendent; and
organizing the first data and second data into an output based on traversing the hierarchical structure.

10. The method of claim 9, wherein organizing the data from the first node and second node into the output comprises:
extracting second data of the second node; and
extracting first data of the first node.

11. The method of claim 10, further comprising:
compiling the first data and second data into a document.

12. The method of claim 10, wherein organizing the data, from the first node and second node a document comprises:
determining an audience to receive the output.

13. The method of claim 12, further comprising:
creating the document from the output, the output having content based on the audience.

14. A method of displaying data on a user interface, comprising:
displaying a first node on a tree structure on a portion of the user interface;
displaying a second node on the tree structure on the portion of the user interface, wherein a second node is associated with the first node;
extracting data based on a hierarchical relationship of the first node and the second node on the tree structure, wherein the extracted data depends the ancestral relationship of the second node to the first node; and
displaying the extracted data on a second portion of the user interface.

15. The method of claim 14, wherein displaying the extracted data on the second portion of the user interface comprises:
determining an audience associated with the extracted data.

16. The method of claim 15, further comprising:
determining the extracted data based the audience.

17. The method of claim 14, wherein the first node and the second node are each associated with an object.

18. The method of claim 17, wherein each object has one or more states that define a status of each object.

19. The method of claim 17, further comprising;
creating a copy of each object by dragging and dropping each object to other nodes on the tree structure,

20. The method of claim 17, further comprising:
creating a reference to each object by dragging and dropping each object to other nodes on the tree structure.
